(19) United States
(12) Patent Application Publication
(10) Pub. No.: US 2010/0133208 A1
(43) Pub. Date: Jun. 3, 2010

(54) SHELF FOR DEPOSITING A KEYBOARD

(75) Inventors: Kwon Il Seo, Seoul (KR); Ki Woong Seo, Gyeonggi-do (KR)

Correspondence Address: Jae Y. Park, Kile, Goekjian, Reed & McManus, PLLC, 1200 New Hampshire Ave. NW, Suite 570, Washington, DC, 20036, US

(73) Assignee: JUNG WUN SEO, Hwaseong-si, Gyeonggi-do (KR)

(21) Appl. No.: 12/596,310

(22) PCT Filed: Apr. 25, 2008
(86) PCT No.: PCT/KR2008/002356

§ 371 Date: Oct. 16, 2009

(30) Foreign Application Priority Data
Apr. 30, 2007 (KR) 10-2007-0042199

(51) Int. Cl. A47F 7/00; A47B 81/00; G09F 23/00; F21V 33/00; F21L 4/00; H01R 13/60

(52) U.S. Cl. 211/26; 40/358; 362/127; 362/157; 439/527

(57) ABSTRACT

A keyboard storing shelf capable of not only receiving a computer keyboard but also storing various things at an upper part thereof above the keyboard, such that a user can more conveniently work with a computer especially in narrow spaces such as a public PC mom. In the keyboard storing shelf comprising a panel having a board form for putting things thereon, a leg supporting the panel, and a fixing member fixing the panel to an upper part of the leg so as to store a keyboard in a space formed at a lower part of the panel, the leg comprises a base placed at a mounting position, a supporter disposed at an upper part of the base to uphold the panel, and a connection member connecting the base to a rear end of the supporter, and supports the panel at both sides with respect to a length direction of the panel.

### TECHNICAL FIELD

The present invention relates to a shelf capable of not only receiving a computer keyboard but also storing various things at an upper part thereof above the keyboard, such that a user can more conveniently work with a computer especially in narrow spaces such as an office or a public PC room or at home.

### BACKGROUND ART

In general, a keyboard for inputting certain commands to a computer is installed in front of a monitor. When the installation space of the keyboard is so small and narrow, it is inconvenient to use the keyboard along with other things put around the keyboard.

For example, in a public PC room, lots of computers are arranged in a limited interior space and for this reason, a table to install thereon a monitor and a keyboard does not have an enough space for further putting user's things such as snacks, cigarettes, a lighter, an ash tray, a wallet, a cup, a cup of noodle soup and the like.

Accordingly, those things can hardly be used together with the keyboard. When users want to use the things, they need to temporarily stop using the computer and put aside the keyboard to ensure a predetermined space to use the things.

Otherwise, for example, if a user has a drink or noodle soup while using the keyboard, the drink or the noodle soup might be poured on the keyboard. In this case, it is very annoying to clean out the poured drink or food.

### DISCLOSURE

### Technical Problem

Therefore, the present invention has been made in view of the above problems, and it is an object of the present invention to provide a shelf capable of storing not only a keyboard but also various things at an upper part thereof above the keyboard such that a user can more conveniently use the keyboard especially in narrow spaces such as a public PC room.

### Technical Solution

In accordance with an aspect of the present invention, the above and other objects can be accomplished by the provision of a keyboard storing shelf comprising a panel having a board form for putting things thereon, a leg supporting the panel, and a fixing member fixing the panel to an upper part of the leg to store a keyboard in a space formed at a lower part of the panel, wherein the leg comprises a base placed at a mounting position; a supporter disposed at an upper part of the base to uphold the panel; and a connection member connecting the base to a rear end of the supporter, and supports the panel at both sides with respect to a length direction of the panel.

In accordance with another aspect of the present invention, there is provided a keyboard storing shelf comprising a panel having a board form to put things thereon; a leg supporting the panel and including a USB port disposed at one or both sides thereof to electrically connect a computer main body with a convenient device; a fixing member for fixing the panel to an upper part of the leg; a lamp mounted to the panel and adapted to emit light by being supplied with power, and an advertising member mounted to the panel, and receiving a keyboard in a space formed at a lower part of the panel.

### Advantageous Effects

### DESCRIPTION OF DRAWINGS

The above and other objects, features and other advantages of the present invention will be more clearly understood from the following detailed description taken in conjunction with the accompanying drawings, in which:

FIG. 1 is a perspective view of a keyboard storing shelf according to the present invention;

FIG. 2 is a perspective view showing a used state of the keyboard storing shelf according to the present invention;

FIG. 3 is a side view showing the used state of the keyboard storing shelf according to the present invention;

FIG. 4 is a plan view showing the used state of the keyboard storing shelf according to the present invention;

FIG. 5 is an enlarged front-sectional view showing a panel as fixed, according to the present invention;

FIG. 6 is a side-sectional view showing a lamp as installed, according to one embodiment of the present invention;

FIG. 7 is a plan view showing the installed lamp according to the embodiment of the present invention;

FIG. 8 is a plan view showing an LED as installed according to the present invention;

FIG. 9 is a sectional view cut along a line A-A of FIG. 8, showing the installed LED;

FIG. 10 shows an installed state of an LED according to another embodiment of the present invention;

FIG. 11 is a side-sectional view of an auxiliary light emitting member according to the present invention;

FIG. 12 is a side-sectional view showing the state where the auxiliary light emitting member and a panel are assembled;

FIG. 13 is a plan view showing the state where the auxiliary light emitting member and the panel are assembled; and

FIG. 14 is a picture showing the keyboard storing shelf according to the present invention being applied to a public PC room.

### BEST MODE

Hereinafter, exemplary embodiments of the present invention will be described in detail with reference to the accompanying drawings.

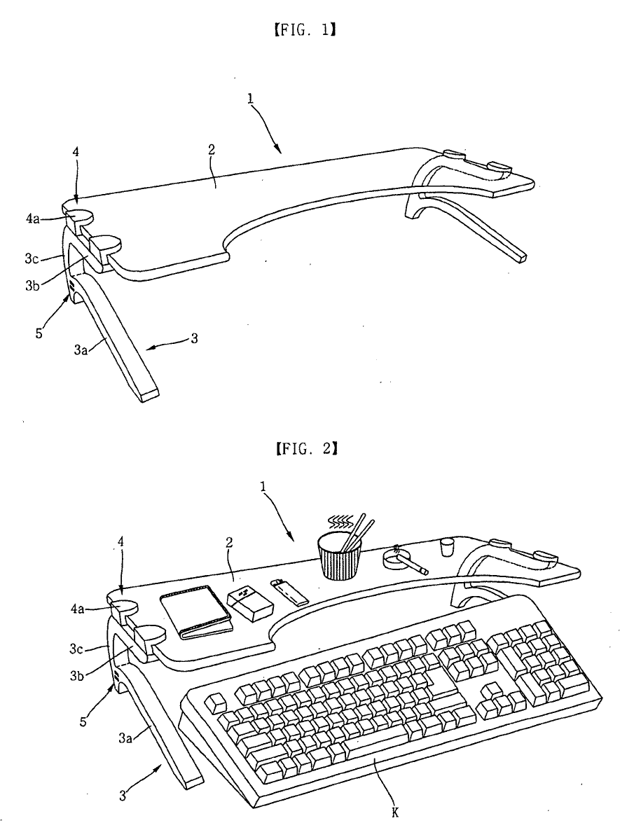

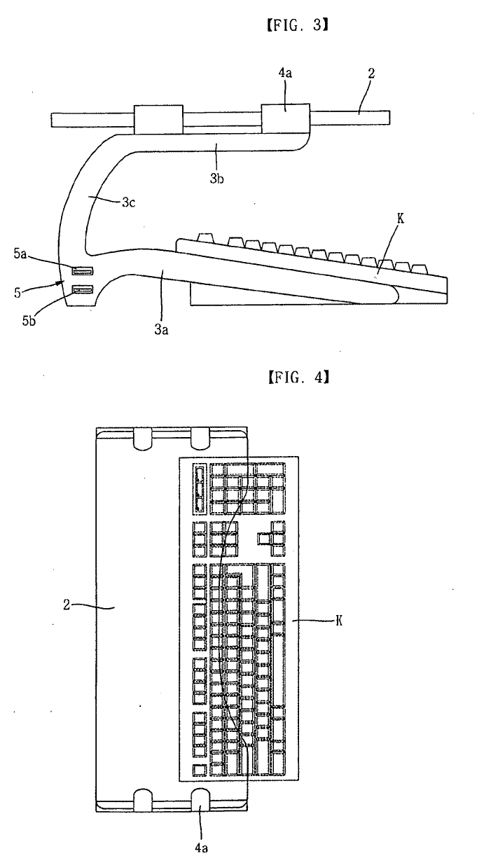

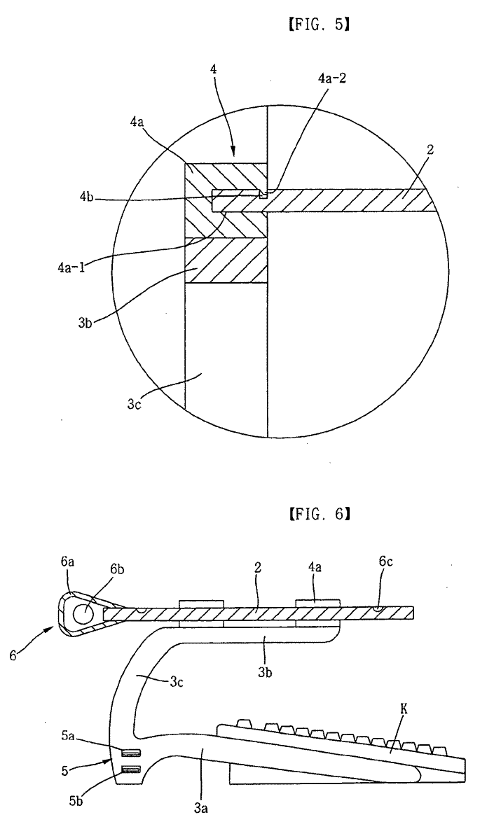

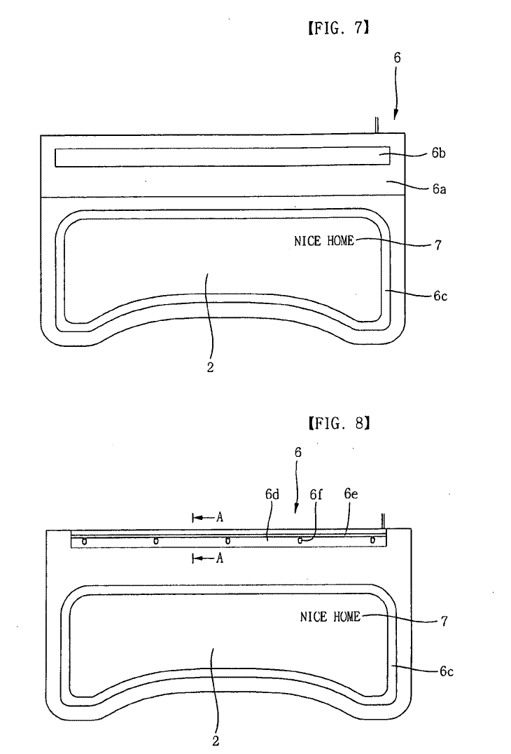

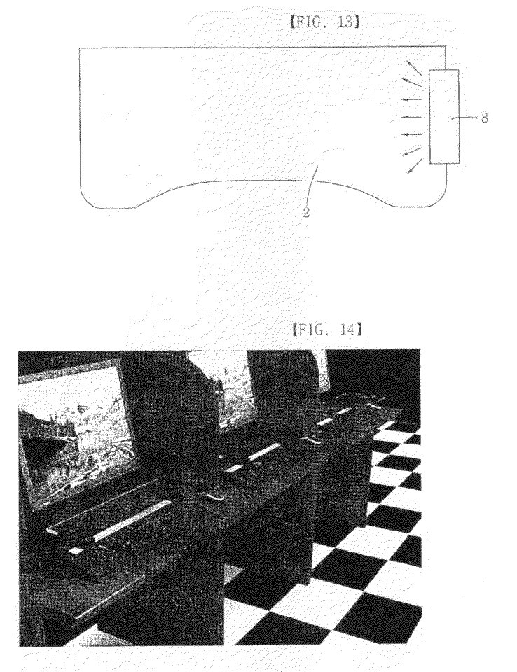

FIG. 1 is a perspective view of a keyboard storing shelf according to the present invention, FIG. 2 is a perspective view of the keyboard storing shelf in use, FIG. 3 is a side view of the keyboard storing shelf in use, and FIG. 4 is a plan view of the keyboard storing shelf in use. FIG. 6 is a side-sectional view of a lamp being installed, and FIG. 8 through FIG. 10 are views showing an LED according to the present invention being installed. FIG. 11 through FIG. 13 show the states before and after an auxiliary light emitting member is mounted to a panel. FIG. 14 is a picture showing the keyboard storing shelf being applied in a public PC room.

As shown in the drawings, a keyboard storing shelf 1 according to the present invention comprises a panel 2 for putting things thereon, a leg 3 for supporting the panel 2, and a fixing member 4 for fixing the panel 2 to an upper part of the leg 3.

The above-structured keyboard storing shelf 1 receives a keyboard K in a space S formed at a lower part of the panel 2, and stores necessary things in a space disposed vertically at an upper part of the keyboard K, thereby enabling effective utilization of a small space.

More particularly, the panel 2 is in the form of a board to put things thereon and preferably made of a transparent material to enable a user to view the keyboard K therethrough. For example, transparent acryl, polycarbonate or tempered glass may be applied as the material of the panel 2.

The leg 3 supporting the panel 2 may have a variety of configurations. In this embodiment shown in the drawings, a pair of the legs 3 are provided to support the panel 2 at both sides.

The leg 3 comprises a base 3a placed at a mounting position, supporters 3b disposed at an upper part of the base 3a to uphold the panel 2, and a connection member 3c connecting the base 3a to rear ends of the respective supporters 3b. In this embodiment, for more unique design, the base 3a of the leg 3 has a curve form sloping upward.

Here, the distance between the two legs 3 is properly set to receive the keyboard K. When the distance between the legs 3 is too great, the whole volume of the keyboard storing shelf is increased, which is against the object of the invention.

A USB port 5 is mounted to one side or both sides of the legs 3 to electrically connect a main body of a computer with a convenient device of the main body. The USB port 5 is generally known in the field as a device functioning as an electric terminal between the computer main body and the convenient device.

The USB port 5 comprises an input port 5a and an output port 5b. The input port 5a is connected to the computer main body while the output port 5b is electrically connected with the input port 5a and also connected with the convenient device. Therefore, the input port 5a is kept in connection with the computer main body through a cable during use. When the convenient device such as a mobile phone is required to be electrically charged, the charging can be achieved by inserting a terminal of the cable connected to the mobile phone in an output terminal.

The fixing member 4 that fixes the panel 2 can be in various types of structures. According to one embodiment of the present invention, the fixing member 4 includes a holder 4a attached to the supporter 3b of the leg 3 to insert therein the panel 2, and a connection recess 4b formed on the panel 2 to receive a leading end of the holder 4a.

In the holder 4a, a slot 4a-1 is opened to insert and fix the panel 2, and a protrusion 4a-2 is formed on an inner leading end of the slot 4a-1 to be inserted in the connection recess 4b of the panel 2. When the panel 2 is forcedly inserted in the slot 4a-1 of the holder 4a, the protrusion 4a-2 disposed at the leading end is widened outward, thereby holding elasticity. In this state, when the panel 2 reaches an assembling position, the protrusion 4a-2 is inserted in the connection recess 4b formed at the panel 2 such that the holder 4a is securely engaged with the panel 2.

The keyboard storing shelf 1 may further comprise a lighting member 6 to decoratively illuminate the panel 2 day and night.

As shown in FIG. 6 and FIG. 7, the lighting member 6 comprises a cover 6a and a lamp 6b mounted inside the cover 6a like other generally known lighting units. Preferably, the lighting member 6 is structured in such a manner that the lamp 6b is mounted to face one lateral side of the panel 2 so that light emitted from the lamp 6b can be reflected along a surface corresponding to the thickness of the panel 2.

The cover 6a not only prevents dazzling by the light by blocking the light emitted from the lamp 6b but also improves the illumination effect by focusing the light to a thickness portion of the panel 2. When the light from the lamp 6b is thus focused to the thickness portion of the panel 2 and reflected broadly, the panel 2 would seem gently illuminated.

In order to improve the illumination effect of the lighting member 6, a reflection groove 6c may be formed along the circumference of the panel 2. By this, when the lamp 6b emits light, the light is focused to the reflection groove 6c and thereby reinforces brightness of the reflection groove 6c. As a result, the illumination effect can be enhanced.

On the other hand, the lighting member 6 according to another embodiment of the present invention may be structured as shown in FIG. 8 through FIG. 10.

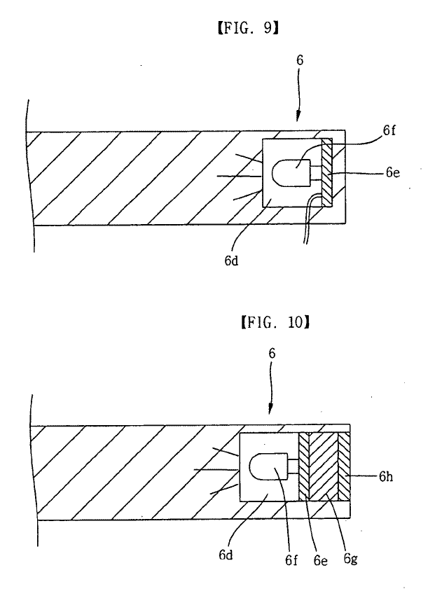

Referring to FIG. 9, the lighting member 6 according to the another embodiment comprises a receiving recess 6d formed at one side of the panel 2, and an LED 6f attached to a PCB 6e and received in the receiving recess 6d. A power cable of the LED 6f, connected to the PCB 6e, is withdrawn to the outside to be supplied with electric power from the outside.

The LED 6f of the lighting member 6 can be supplied with the power by using a battery 6g as shown in FIG. 10. The battery 6g is received in the receiving recess 6d and electrically connected with the PCB 6e. A cover 6h openably covers the receiving recess 6d so that replacement of the battery 6g can be performed as necessary. A wiring structure of the battery 6g will not be described in detail since being generally known in the art.

The keyboard storing shelf according to the embodiment of the present invention further comprises an advertising member.

The advertising member utilizes the illumination effect of the lighting member 6. More specifically, an advertising recess 7 containing advertisement contents is formed at one side on the surface of the panel 2 in the form of letters such as “Nice Home” as shown in the drawing. Upon illumination of the lamp 6b, the advertisement contents implemented by the advertising recess 7 can be illuminated brighter than the periphery, accordingly achieving the advertising effect.

Although the advertisement contents expressed by the advertising recess 7 are shown as “Nice Home” in the drawing, this is only by way of an example. That is, diverse advertisement contents can be achieved by varying the shape of the advertising recess 7.

According to another embodiment, the advertising member may be implemented through silk screen printed on the surface, a bottom or an inside of the panel 2. Since the silk screen printing is a generally known technique, detailed description thereof will be omitted.

The keyboard storing shelf according to the embodiment of the present invention further comprises an auxiliary light emitting member 8 besides the lighting member 6. The auxiliary light emitting member 8 is selectively adopted by being removably connected to the panel 2.

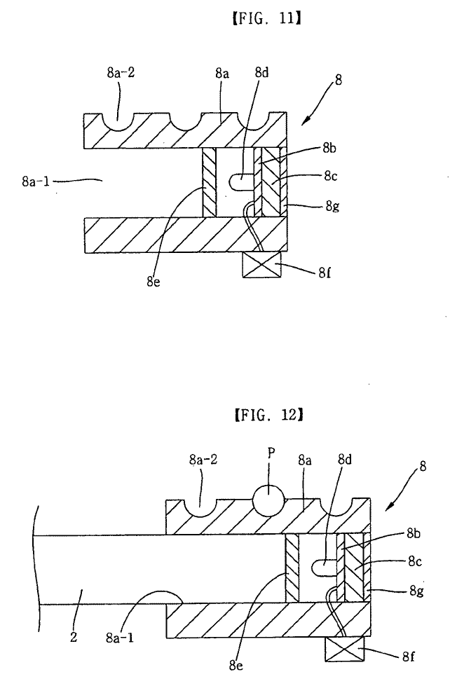

As shown in FIG. 11 and FIG. 12, the auxiliary light emitting member 8 comprises a main body 8a including a slot 8a-1 for engagement with the panel 2, a PCB 8b received in the slot 8a-1 of the main body 8a, a battery 8c electrically connected with the PCB 8b, an LED 8d mounted to the PCB 8b to emit light by electric power supplied by the battery 8c, and a locking protrusion Be formed in front of the LED 8d to protect the LED 8d when the panel 2 is inserted in the slot 8a-1.

The main body 8a, being provided to protect the LED 8d, further includes a fitting groove 8a-2 formed on the outside thereof to insertingly fix writing tools such as a pen P, a switch 8f formed at the outside and connected with the PCB 8b to turn the LED 8d on and off, and a cover 8g openably covering one side of the main body 8a to enable replacement of the battery 8c.

The locking protrusion 8e is made of a transparent material so that the light emitted from the LED 8d can be transmitted to the panel 2 through the locking protrusion 8e.

The above-structured auxiliary light emitting member 8 operates as follows. When the switch 8f is turned on, with the slot 8a-1 engaged with a lateral side of the panel 2, the LED 8d emits light. The light from the LED 8d is reflected along the thickness portion of the panel 2, thereby gently illuminating the whole area of the panel 2.

The keyboard storing shelf 1 according to another embodiment of the present invention comprises the panel 2 having a board form to put things thereon, the leg 3 supporting the panel 2 and including the USB port 5 disposed at one or both sides thereof to electrically connect the computer main body with the convenient device, the fixing member 4 for fixing the panel 2 to the upper part of the leg 3, the lighting member 6 mounted to the panel 2 and adapted to emit light by being supplied with power, and an advertising member mounted to the panel 2.

The above keyboard storing shelf 1 is characterized in that the USB port 5, the lighting member 6 and the advertising member are integrally formed. Since the USB port 5, the lighting member 6 and the advertising member have already been explained, description thereof will be omitted.

When the keyboard storing shelf 1 is in use, the keyboard K is received in a space formed at a lower part of the panel 2 while various things are put on the panel 2. Thus, the keyboard K can be safely used.

That is, since the keyboard storing shelf 1 utilizes a vertical space with respect to the keyboard K, storage of things other than the keyboard K can be very effectively achieved especially at a small and narrow space such as a public PC room.

In addition, by decorating the panel using the lighting member or the auxiliary light emitting member, an atmosphere of the place using the keyboard storing shelf can be greatly improved. Furthermore, at home, the lighting effect of the panel can be utilized as a night light.

Moreover, an advertising effect can be obtained through the panel.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The keyboard storing shelf according to the embodiments of the present invention is capable of not only receiving a keyboard in a space formed under a panel thereof but also conveniently storing things except the keyboard. The panel of the keyboard storing shelf can be utilized as lighting by using a lighting member or an auxiliary light emitting member, thereby improving an atmosphere of the place using the keyboard storing shelf. Also, an advertising effect can be obtained by providing an advertising member to the panel.

1. A keyboard storing shelf comprising a panel having a board form for putting things thereon, a leg supporting the panel, and a fixing member fixing the panel to an upper part of the leg to store a keyboard in a space formed at a lower part of the panel,
wherein the leg comprises:
a base placed at a mounting position;
a supporter disposed at an upper part of the base to uphold the panel; and
a connection member connecting the base to a rear end of the supporter, and supports the panel at both sides with respect to a length direction of the panel.

2. The keyboard storing shelf according to claim 1, wherein the leg includes a USB port mounted to one side or both sides thereof to electrically connect a main body of a computer with a convenient device.

3. The keyboard storing shelf according to claim 1, wherein the fixing member comprises:
a holder attached to the supporter of the leg, including a slot for inserting therein the panel and a protrusion formed on an inner leading end of the slot; and
a connection recess formed on the panel to receive the protrusion of the holder.

4. The keyboard storing shelf according to claim 1, wherein the panel is made of a transparent material so that the keyboard can be seen through the panel, and includes a reflection groove formed on a surface thereof.

5. The keyboard storing shelf according to claim 1, wherein the panel further includes a lighting member comprising a lamp or an LED which emits light by being supplied with power.

6. The keyboard storing shelf according to claim 1, wherein the panel further includes an advertising member which may be implemented by silk screen printed on the surface, a bottom or an inside of the panel.

7. The keyboard storing shelf according to claim 1, wherein the panel further includes an auxiliary light emitting member removably mounted to a lateral side thereof.

8. The keyboard storing shelf according to claim 7, wherein the auxiliary light emitting member comprises:
a main body including a slot for inserting therein the panel;
a PCB received in the slot of the main body;
a battery electrically connected with the PCB;
an LED mounted to the PCB to emit light by power supplied from the battery; and
a locking protrusion disposed in front of the LED to protect the LED when the panel is inserted in the slot.

9. A keyboard storing shelf comprising:
a panel having a board form to put things thereon;
a leg supporting the panel and including a USB port disposed at one or both sides thereof to electrically connect a computer main body with a convenient device;
a fixing member for fixing the panel to an upper part of the leg;
a lighting member mounted to the panel, comprising a lamp adapted to emit light by being supplied with power; and
an advertising member mounted to the panel,
and receiving a keyboard in a space formed at a lower part of the panel.

10. The keyboard storing shelf according to claim 9, wherein the fixing member comprises:
a holder attached to the supporter of the leg, including a slot for inserting therein the panel and a protrusion formed on an inner leading end of the slot; and
a connection recess formed on the panel to receive the protrusion of the holder.

11. The keyboard storing shelf according to claim 9, wherein the leg comprises:
a base placed at a mounting position;
a supporter disposed at an upper part of the base to uphold the panel; and
a connection member connecting the base to a rear end of the supporter, and supports the panel at both sides with respect to a length direction of the panel.

12. The keyboard storing shelf according to claim 9, wherein the panel is made of a transparent material so that the keyboard can be seen through the panel, and includes a reflection groove formed on a surface thereof so that the light emitted from the lamp is focused to the reflection groove.

13. The keyboard storing shelf according to claim 9, wherein the panel further includes an advertising member which may be implemented by silk screen printed on the surface, a bottom or an inside of the panel.

14. The keyboard storing shelf according to claim 9, wherein the panel further includes an auxiliary light emitting member removably connected to a lateral side thereof, the auxiliary light emitting member comprising:
a main body including a slot for inserting therein the panel;
a PCB received in the slot of the main body;
a battery electrically connected with the PCB;
an LED mounted to the PCB to emit light by power supplied from the battery; and
a locking protrusion disposed in front of the LED to protect the LED when the panel is inserted in the slot.
